(19) United States
(12) Patent Application Publication
(10) Pub. No.: US 2009/0230669 A1
(43) Pub. Date: Sep. 17, 2009

(54) BOOK CLIP

(76) Inventor: Myung-kuk Kang, Seoul (KR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/909,094

(22) PCT Filed: Mar. 23, 2006
(86) PCT No.: PCT/KR06/01065

§ 371 Date: Sep. 19, 2007

(30) Foreign Application Priority Data
Mar. 25, 2005 (KR) 10-2005-0024830
May 3, 2005 (KR) 10-2005-0037170

(51) Int. Cl. B42D 9/00

(52) U.S. Cl. 281/42

(57) ABSTRACT

The present invention relates to a book clip, and more particularly, to a book clip that is easy to carry and used to securely fix both pages of an opened book. The book clip includes a transverse rod shorter than a transversal length of an opened book by a predetermined length, leaf supporting rods bent at the ends of the transverse rod to be respectively positioned on the front side of the opened book, and an elastic supporting rod vertically protruded from an approximately central region of the transverse rod to support the rear side of the opened book. Thus, the burden due to the weight and the volume of the book clip that a user feels when carrying the book clip is mitigated, and the user can open the book anywhere to fix desired pages of the book.

### BACKGROUND OF THE INVENTION

1. Field of the Invention

The present invention relates to a book clip, and more particularly, to a book clip that is easy to carry and used to securely fix both pages of an opened book.

2. Description of the Related Art

Generally, those who study with books open on a specific page and repeatedly read the contents contained in the corresponding page of the opened book. In this case, since a plurality of sheets is stacked and integrally bound into a book, leaves of the book spontaneously turn over departing from a reader's desire. Due to this, the reader must open the desired page again or place something on the pages of the opened book to prevent the leaves of the book from spontaneously turning over.

In order to solve the above-mentioned problem, as shown in FIG. 6, a book holder is widely used. The book holder includes a supporting plate 100 on which the book is placed, a leaf-fixing part 200 formed in the front lower side of the supporting plate 100 such that the leaves of the book are inserted into a fixing recess 201 formed therein so that desired leaves of the book are fixed for the reader to see the desired pages of the book, and a support 100 formed in the rear side of the supporting plate 100 such that the reader can fix the book at a desired angle to read the book.

However, since the supporting plate and the leaf-fixing part of the conventional book holder are made of wood, a synthetic resin, or the like, the conventional book holder has a large volume and is heavy. Thus, the conventional book holder is difficult to carry. Moreover, it is difficult to use the conventional book holder when reading a book on a desk, outdoors, or on public transportation.

### SUMMARY OF THE INVENTION

Therefore, the present invention has been made in view of the above-mentioned problems, and an aspect of the present invention is to provide a book clip that is convenient to carry and securely fixes both opened leaves of a book.

Another aspect of the present invention is to provide a book clip for securely fixing opened leaves of a book and for conveniently turning the leaves over.

A still another aspect of the present invention is to provide a book clip having a central part for locking a binding part of a book.

A still another aspect of the present invention is to provide a book clip for securely fixing leaves of a book even when a number of turned-over pages of a book is changed.

In accordance with one aspect, the present invention provides a book clip including a transverse rod shorter than a transversal length of an opened book by a predetermined length, leaf supporting rods bent at the ends of the transverse rod to be respectively positioned on the front side of the opened book, and an elastic supporting rod vertically protruded from an approximate central region of the transverse rod to support the rear side of the opened book.

Preferably, the book clip further includes protrusions formed at the ends of the leaf supporting rods and being thicker than a diameter of the leaf supporting rods.

Moreover, the elastic supporting rod includes a pair of elastic supporting parts spaced apart from each other by a predetermined distance.

Additionally, one of the leaf supporting rods is positioned from the elastic supporting rod farther than the other one of the leaf supporting rods.

### BRIEF DESCRIPTION OF THE DRAWINGS

FIG. 1 is a perspective view illustrating a book clip according to a preferred embodiment of the present invention;

FIG. 2 is a perspective view illustrating the use of the book clip in FIG. 1;

FIG. 3 is a perspective view illustrating a book clip according to another preferred embodiment of the present invention;

FIG. 4 is a front view of the book clip in FIG. 3;

FIG. 5 is a perspective view illustrating the use of the book clip in FIG. 3; and

FIG. 6 is a perspective view illustrating a conventional book holder.

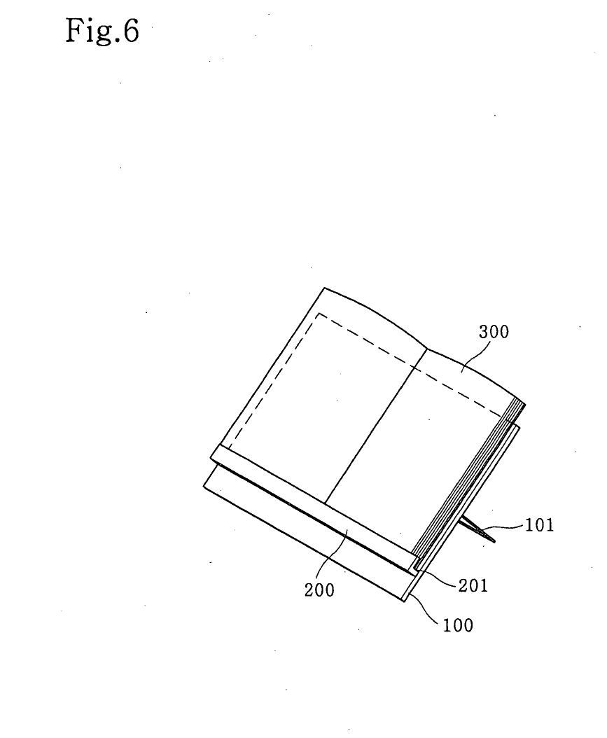

### DESCRIPTION OF THE PREFERRED EMBODIMENTS

Hereinafter, a book clip according to preferred embodiments of the present invention will be described in detail with reference to the accompanying drawings.

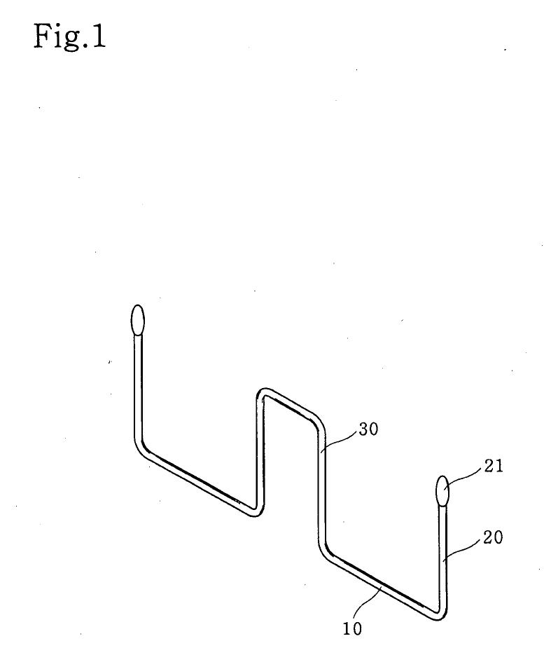

FIG. 1 is a perspective view illustrating a book clip according to a preferred embodiment of the present invention. As shown in the drawing, the book clip according to the preferred embodiment of the present invention is designed such that leaf supporting rods 20 are integrally made of an elastic material such as metal, synthetic resin, or the like by bending lateral ends of a transverse rod 10 to a predetermined direction, and an elastic supporting rod 30 is vertically protruded from an approximately central region of the transverse rod 10 to fix leaves of an opened book, and that is convenient to carry.

The transverse rod 10 is made of a wire rod such as a metal wire, a metal rod, a synthetic resin with a predetermined strength and elasticity, positioned at the lower side or an upper corner of the opened book such that the leaf supporting rods 20 elastically support the leaves of the opened book.

The leaf supporting rods 20 are bent from the lateral ends of the transverse rod 10 in a predetermine direction to support the front sides of the both leaves of the opened book such that the reader may open and fix the desired pages of the book.

The elastic supporting rod 30 is vertically protruded from an approximate central region of the transverse rod 10 to support the rear side of the opened book, so that the leaf supporting rods 20 securely fix the leaves of the elastically opened book in association with the transverse rod 10 and the elastic supporting rod 30.

Moreover, the elastic supporting rod 30 has an aesthetically pleasing appearance and may be formed by bending a part of the transverse rod for the convenient manufacturing.

Moreover, the leaf supporting rods 20 have protrusions 21 formed at the ends of the leaf supporting rods 20 thicker than a diameter of the leaf supporting rods 20 such that a contact area between the leaf supporting rods 20 and the leaves of the opened book is minimized and the leaves of the opened book are securely fixed. As a result, when turning the leaves of the opened book over, the leaves can easily be freed from the leaf supporting rods 20.

Additionally, a connector for connecting the transverse rod 10 to the leaf supporting rods 20 and a connector for connecting the transverse rod 10 to the elastic supporting rod 30 are preferably rounded to increase the elasticity thereof.

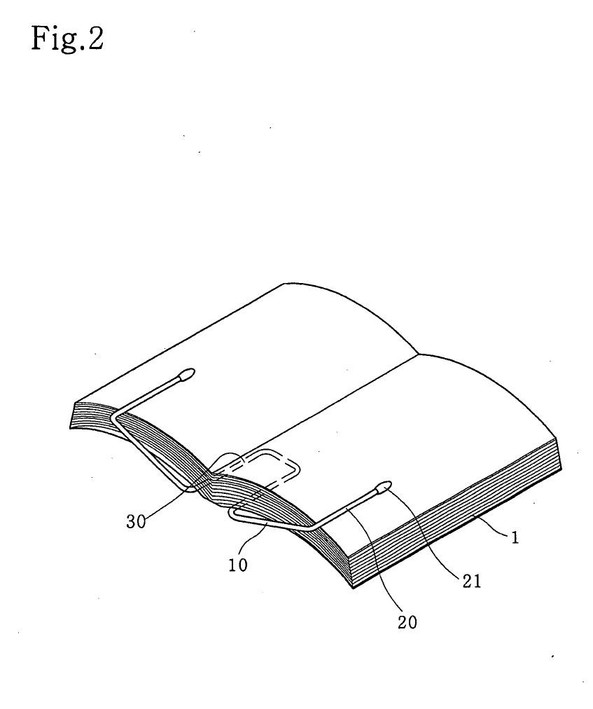

FIG. 2 is a perspective view illustrating the use of the book clip in FIG. 1. As shown in the drawing, in the book clip structured as described above, after opening a book 1, the leaf supporting rods 20 are positioned at the lower front side or the upper front side of the leaves of the opened book 1 and the elastic supporting rods 30 support the rear side of the opened book 1 so that the opened book 1 is fixed open by the elasticity of the transverse rod 10.

Moreover, at this time, since the leaf supporting rods 20 for supporting the leaves of the opened book are made of a wire rod such as a metal wire, an area covered by the leaf supporting rods is minimized and the reader can conveniently read the contents in the unopened leaves of the opened book without moving the book clip here to there.

Moreover, since the above-mentioned protrusions 21 are formed at the ends of the leaf supporting rods 20, the contact areas between the leaf supporting rods 20 and the opened book 1 are reduced and the protrusions 21 support the unfolded leaves of the opened book so that the leaves are more conveniently turned over in the state of fixing the book using the book clip.

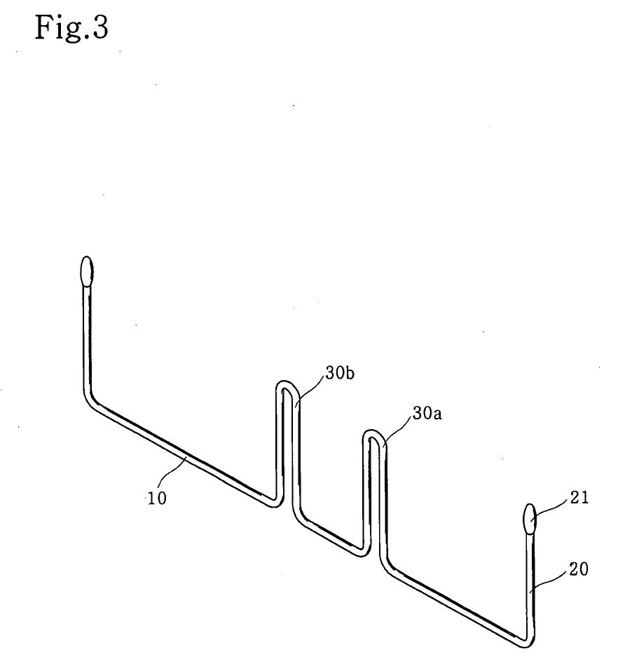

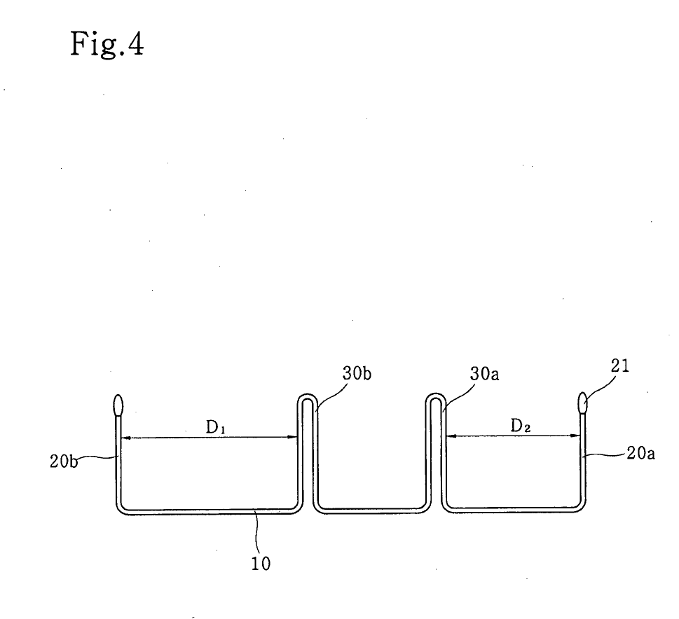

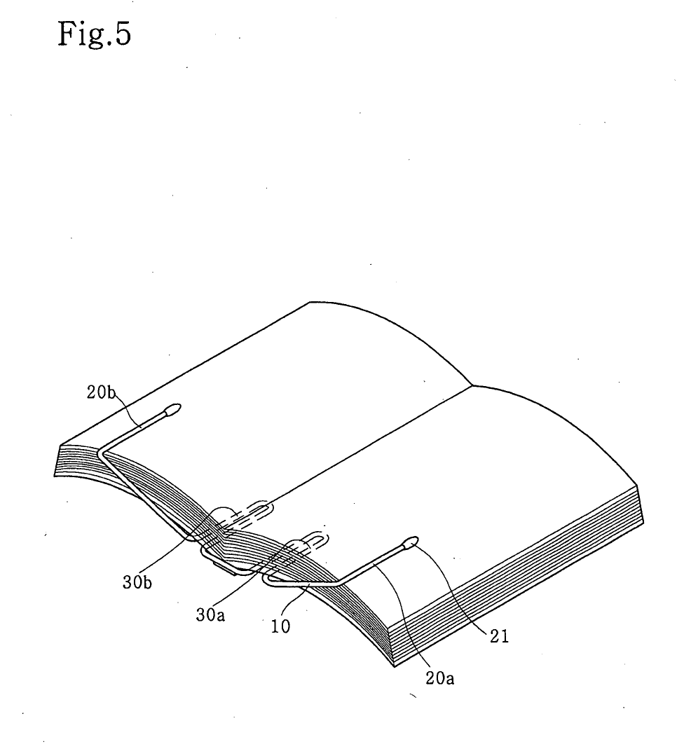

FIG. 3 is a perspective view illustrating a book clip according to another preferred embodiment of the present invention, FIG. 4 is a front view of the book clip in FIG. 3, and FIG. 5 is a perspective view illustrating the use of the book clip in FIG. 3. The book clip according to this preferred embodiment of the present invention includes all the components of the book clip of the prior preferred embodiment of the present invention. However, the above-mentioned elastic supporting rod includes a pair of elastic supporting parts spaced apart from each other such that the elastic supporting parts 30a and 30b support the rear side of the opened book 1 and the binding part of the book is inserted into the space defined between the elastic supporting parts 30a and 30b.

Due to this structure, when fixing the book clip to the opened book 1, the binding part of the opened book is inserted into the space between the elastic supporting parts 30a and 30b to prevent the book clip fixed to the opened book 1 from being pushed to the side of the book. Thus, the book clip can securely fix the opened book and the book clip is prevented from being separated from the opened book.

Additionally, one of the leaf supporting rods is spaced apart from the elastic supporting parts 30a and 30b by a distance D1 longer than a distance between the other of the leaf supporting rods and the elastic supporting parts 30a and 30b.

By doing so, although one side of the opened book 1 is thicker. than the other side of the opened book 1 when the book 1 is opened, the leaf supporting rod 20a near to the elastic supporting parts is positioned on the thin leaf of the opened book and the leaf supporting rod 20b farther from the elastic supporting parts is positioned on the thick leaf of the opened book so that the book clip steadily supports the opened book.

As described above, since the book clip includes the transverse rod, the leaf supporting rods, and the elastic supporting rod, the book clip is convenient to carry and securely fixing the leaves of the opened book can be easily achieved. Thus, the burden due to the weight and the volume of the book clip that a user feels when carrying the book clip is mitigated, and the user can open the book anywhere to fix desired pages of the book.

Moreover, since the protrusions are formed at the ends of the leaf supporting rods to minimize frictional areas between the leaves of the book and the leaf supporting rods, it is more convenient to turn the leaves of the book over and to fix the leaves after turning the leaves over.

Additionally, since the book clip has a pair of elastic supporting parts such that the binding part of the book is locked by the central area of the book clip, the book clip is prevented from being pushed toward sides of the leaves of the book when the book clip fixes the leaves of the book so that the book clip is securely fixed to the book.

Moreover, since one of the leaf supporting rods is spaced apart from the elastic supporting part farther than the other of the leaf supporting rods such that the leaves of the book are securely fixed even when the quantity of the turned pages is changed, the leaves of the opened book are securely fixed even when the thicknesses of the leaves on either side of the opened book are different from each other.

What is claimed is:

1. A book clip comprising:
a transverse rod shorter than a transversal length of an opened book by a predetermined length;
leaf supporting rods bent at the ends of the transverse rod to be respectively positioned on the front side of the opened book; and
an elastic supporting rod vertically protruded from an approximate central region of the transverse rod to support the rear side of the opened book.

2. The book clip as set forth in claim 1, further comprising protrusions formed at the ends of the leaf supporting rods and being thicker than a diameter of the leaf supporting rods.

3. The book clip as set forth in claim, wherein the elastic supporting rod comprises a pair of elastic supporting parts spaced apart from each other by a predetermined distance.

4. The book clip as set forth in any one of claims 1 to 3, wherein one of the leaf supporting rods is positioned from the elastic supporting rod farther than the other one of the leaf supporting rods.
